(19) United States
(12) Patent Application Publication
(10) Pub. No.: US 2022/0413517 A1
(43) Pub. Date: Dec. 29, 2022

(54) MOVING BODY, CONTROL METHOD, AND PROGRAM

(71) Applicant: SONY GROUP CORPORATION, TOKYO (JP)

(72) Inventor: SHUN LEE, TOKYO (JP)

(21) Appl. No.: 17/620,835

(22) PCT Filed: Jun. 18, 2020
(86) PCT No.: PCT/JP2020/023955

§ 371 Date: Dec. 20, 2021

(30) Foreign Application Priority Data
Jun. 27, 2019 (JP) 2019-119965

(51) Int. Cl. G05D 1/10; G06V 20/64; G06V 20/17; G06V 10/82; B64C 39/02

(52) U.S. Cl. CPC G05D 1/106; G06V 20/64; G06V 20/17; G06V 10/82; B64C 39/024; B64C 2201/127; B64C 2201/141

(57) ABSTRACT

The present disclosure relates to a moving body, a control method, and a program that enable realization of safer movement and stop. A safety degree estimation unit estimates a safety degree according to a lapse of time of its own machine in a moving state on the basis of external environmental information regarding an external environment, and a movement control unit controls movement of the own machine on the basis of the estimated safety degree. Technology according to the present disclosure can be applied to, for example, a moving body such as a drone.

### TECHNICAL FIELD

The present disclosure relates to a moving body, a control method, and a program, and particularly to a moving body, a control method, and a program that enable realization of safer movement and stop.

### BACKGROUND ART

Conventionally, there is a moving body equipped with a sensor for observing an external environment in order to autonomously move without colliding with an obstacle or the like in the external environment. In addition to autonomous moving robots such as a drone, a vehicle, a vessel, and a vacuum cleaner that move autonomously, the moving body includes a device or the like that is attached to the moving body and moves. As the sensor, for example, a camera, a sonar, a radar, a light detection and ranging or laser imaging detection and ranging (LiDER), or the like is mainly used.

Under such circumstances, Patent Document 1 discloses a technique in which an unmanned aircraft that performs autonomous landing finds a landing zone on the basis of a three-dimensional evidence grid generated using sensor data from an onboard sensor, and performs flight control to land at one point where a surface of the landing zone has been evaluated.

### CITATION LIST

### Patent Document

Patent Document 1: Japanese Patent Application Laid-Open No. 2015-6874.

### SUMMARY OF THE INVENTION

### Problems to be Solved by the Invention

A moving body that autonomously moves needs to move or stop in an environment with a low risk of colliding with an obstacle or a dynamic object in order to prevent a failure of its own machine. However, depending on the environment, there is a possibility that the own machine is exposed to danger due to presence of an obstacle or approach of a dynamic object.

The present disclosure has been made in view of such a situation, and is intended to enable realization of safer movement and stop.

### Solutions to Problems

A moving body of the present disclosure is a moving body including: a safety degree estimation unit that estimates a safety degree according to a lapse of time of its own machine in a moving state on the basis of external environmental information regarding an external environment; and a movement control unit that controls movement of the own machine on the basis of the estimated safety degree.

A control method of the present disclosure is a control method, in which a moving body estimates a safety degree according to a lapse of time of its own machine in a moving state by using external environmental information regarding an external environment, and controls movement of the own machine on the basis of the estimated safety degree.

A program of the present disclosure is a program for causing a processor to execute processing of: estimating a safety degree according to a lapse of time of a moving body in a moving state by using external environmental information regarding an external environment; and controlling movement of the moving body on the basis of the estimated safety degree.

In the present disclosure, a safety degree according to a lapse of time of a moving body in a moving state is estimated by using external environmental information regarding an external environment, and movement of the moving body is controlled on the basis of the estimated safety degree.

### BRIEF DESCRIPTION OF DRAWINGS

FIG. 1 is a diagram for explaining a moving body to which technology according to the present disclosure is applied.

FIG. 2 is a diagram for explaining a period during which a safety degree is estimated.

FIG. 3 is a diagram illustrating an appearance of a moving body.

FIG. 4 is a block diagram illustrating a configuration example of the moving body.

FIG. 5 is a block diagram illustrating a functional configuration example of a control unit.

FIG. 6 is a flowchart for explaining a flow of movement control processing.

FIG. 7 is a diagram for explaining detection of a dynamic object.

FIG. 8 is a diagram for explaining semantic segmentation.

FIG. 9 is a diagram for explaining estimation of a safety degree for each divided space.

FIG. 10 is a diagram for explaining estimation of a safety degree at the time of stop and after stop.

FIG. 11 is a table for explaining estimation of a safety degree of a stop candidate position.

FIG. 12 is a flowchart for explaining a flow of movement control processing.

FIG. 13 is a diagram for explaining estimation of a safety degree for each movement route.

FIG. 14 is a diagram for explaining calculation of a contact probability.

FIG. 15 is a diagram for explaining calculation of a contact probability.

FIG. 16 is a table for explaining estimation of a safety degree of a movement candidate route.

FIG. 17 is a block diagram illustrating another functional configuration example of the control unit.

FIG. 18 is a flowchart for explaining a flow of movement control processing.

FIG. 19 is a diagram illustrating an example of presentation information.

FIG. 20 is a diagram illustrating an example of the presentation information.

FIG. 21 is a diagram illustrating an example of the presentation information.

FIG. 22 is a diagram illustrating an example of the presentation information.

FIG. 23 is a diagram illustrating an example of the presentation information.

FIG. 24 is a diagram illustrating an example of the presentation information.

FIG. 25 is a diagram illustrating an example of the presentation information.

### MODE FOR CARRYING OUT THE INVENTION

A mode for carrying out the present disclosure (hereinafter, referred to as an embodiment) will be described below. Note that the description will be given in the following order.

1. Overview of Technology According to the Present Disclosure

2. Configuration of Moving Body

3. Safety Degree Estimation for Each Divided Space Based on External Environmental Information

4. Safety Degree Estimation for Each Movement Route Based on External Environmental Information

5. Safety Degree Estimation Based on External Environmental Information and History Information

6. Examples of Presentation Information

### <1. Overview of Technology According to the Present Disclosure

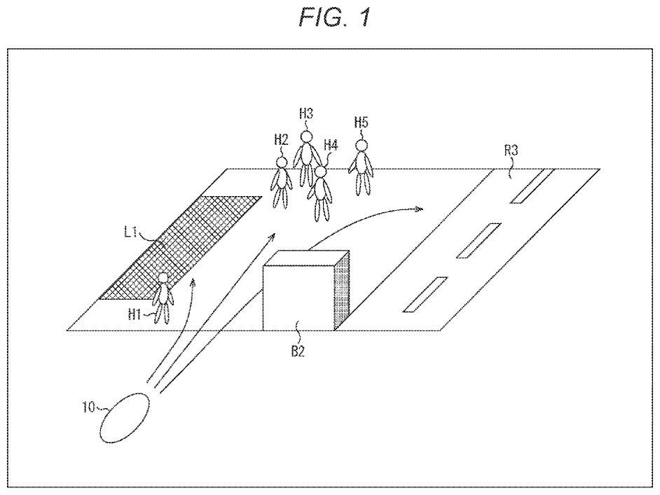

A moving body 10 illustrated in FIG. 1 to which technology according to the present disclosure is applied is configured to estimate a safety degree according to a lapse of time of its own machine in a moving state on the basis of external environmental information regarding an external environment in a moving space, and to control movement of the own machine on the basis of the estimated safety degree.

Specifically, the moving body 10 recognizes a state of the external environment on the basis of sensor data acquired by a sensor (not illustrated). In an example of FIG. 1, a person H1 exists on the front left of the moving body 10, and a lawn L1 exists ahead of the person. Four persons H2, H3, H4, and H5 exist in front of the moving body 10, a building B2 exists on the front right of the moving body 10, and a roadway R3 exists ahead of the building.

The moving body 10 estimates a safety degree on the basis of external environmental information indicating such an external environment.

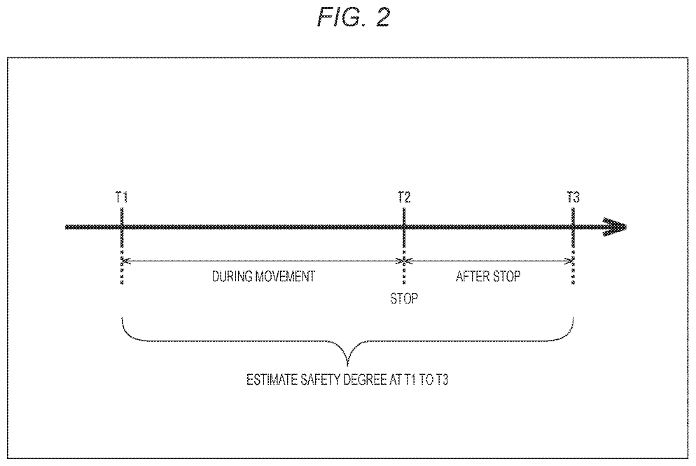

As illustrated in FIG. 2, in a case where a current time is T1, a time at the time of stop is T2, and a time after a lapse of a certain time from the time T2 is T3, a safety degree is an index of safety during movement (times T1 to T2), at the time of stop (time T2), and after stop (times T2 to T3). That is, the moving body 10 estimates a safety degree at the times T1 to T3.

For example, in a case where the moving body 10 advances toward the front left, there is a possibility of coming into contact with the person H1. However, if the moving body moves while avoiding the person H1, it can stop on the lawn L1 ahead of the person. Therefore, it is estimated that the safety degree is high.

In a case where the moving body 10 advances toward the front, there is a possibility of coming in contact with the four persons H2 to H5, and thus, it is estimated that the safety degree is low.

In a case where the moving body 10 advances toward the front right, the building B2 does not move, so that the moving body can move while avoiding the building B2. However, there is a possibility that the moving body comes into contact with a car or the like on the roadway R3 ahead of the building. Therefore, it is estimated that the safety degree is low.

Then, the moving body 10 moves on the basis of the estimated safety degree and stops. In the example of FIG. 1, the moving body 10 moves on a route toward the front left of its own machine, which is estimated to have the highest safety degree, and stops on the lawn L1.

In addition to autonomous moving robots such as a drone, a vehicle, a vessel, and a vacuum cleaner that move autonomously, the moving body includes a device or the like that is attached to the moving body and moves. In the following, an example in which the technology according to the present disclosure is mainly applied to a drone flying in the air will be described. However, in addition to the drone, the technology according to the present disclosure can be applied to autonomous moving robots such as an autonomous traveling vehicle moving on land, an autonomous navigation vessel moving on or under water, and an autonomous moving vacuum cleaner moving indoors.

<2. Configuration of Moving Body>

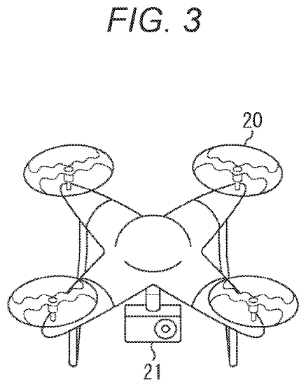

FIG. 3 is a diagram illustrating an appearance of a moving body to which the technology according to the present disclosure (the present technology) is applied.

As described above, a moving body 20 illustrated in FIG. 3 is configured as a drone. Movement of the moving body 20 is a movement by flight. However, it is a movement on land in a case where the moving body 20 is configured as an autonomous traveling vehicle, and it is a movement on or under water in a case where the moving body 20 is configured as an autonomous navigation vessel. Furthermore, it is an indoor movement in a case where the moving body 20 is configured as an autonomous moving vacuum cleaner.

A sensor 21 for observing an external environment is mounted on the moving body 20 in order to autonomously move without colliding with an obstacle or the like in the external environment.

The sensor 21 only needs to be a sensor capable of acquiring a three-dimensional shape of the external environment, and includes, for example, a sonar, a radar, a LiDER, and the like in addition to a depth sensor such as a camera, a stereo camera, and a time of flight (ToF) sensor. Furthermore, the sensor 21 may include a spectral sensor, a polarization sensor, or the like capable of acquiring material and a degree of unevenness of a flat surface existing in the external environment. Sensor data collected by the sensor 21 is used, for example, for movement control of the moving body 20.

The moving body 20 may be configured to move autonomously, or may be configured to move according to a signal from a controller (not illustrated) for operating the moving body 20, which is configured by a transmitter, a personal computer (PC), or the like.

For example, a drone that autonomously flies needs to fly or land in an environment with a low risk of colliding with an obstacle or a dynamic object in order to prevent a failure of its own machine. However, depending on the environment, there is a possibility that the own machine is exposed to danger due to presence of an obstacle or approach of a dynamic object. Furthermore, even in a case where a pilot manually flies the drone by operating the controller, the pilot needs to land at a place where the drone is not exposed to danger at the time of landing or after landing.

Therefore, the moving body 20 of the present technology is configured to recognize the external environment using the sensor 21 mounted on the moving body 20 and realize safer movement and stop.

(Configuration Blocks of Moving Body)

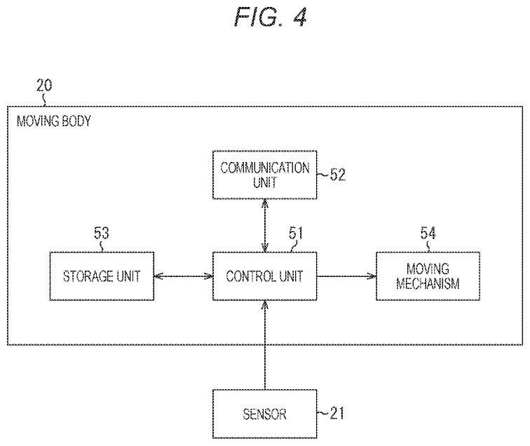

FIG. 4 is a block diagram showing a configuration example of the moving body 20.

The moving body 20 includes a control unit 51, a communication unit 52, a storage unit 53, and a moving mechanism 54.

The control unit 51 includes a processor such as a central processing unit (CPU), a memory, and the like, and controls the communication unit 52, the storage unit 53, the moving mechanism 54, and the sensor 21 by executing a predetermined program. For example, the control unit 51 controls the moving mechanism 54 on the basis of sensor data collected by the sensor 21.

The communication unit 52 includes a network interface or the like, and performs wireless or wired communication with the controller for operating the moving body 20 and any other device. For example, the communication unit 52 may directly communicate with a device to be communicated with, or may perform network communication via a base station or a repeater for Wi-Fi (registered trademark), 4G, 5G, or the like. Furthermore, the communication unit 52 receives GPS information transmitted from a GPS satellite.

The storage unit 53 includes a non-volatile memory such as a flash memory, and stores various types of information according to control of the control unit 51.

The moving mechanism 54 is a mechanism for moving the moving body 20, and includes a flight mechanism, a traveling mechanism, a propulsion mechanism, and the like. In this example, the moving body 20 is configured as a drone, and the moving mechanism 54 includes a motor, a propeller, and the like as a flight mechanism. Furthermore, in a case where the moving body 20 is configured as an autonomous traveling vehicle, the moving mechanism 54 includes wheels or the like as a traveling mechanism. In a case where the moving body 20 is configured as an autonomous navigation vessel, the moving mechanism 54 includes a screw propeller and the like as a propulsion mechanism. The moving mechanism 54 is driven according to control of the control unit 51 to move the moving body 20.

(Functional Configuration Blocks of Control Unit)

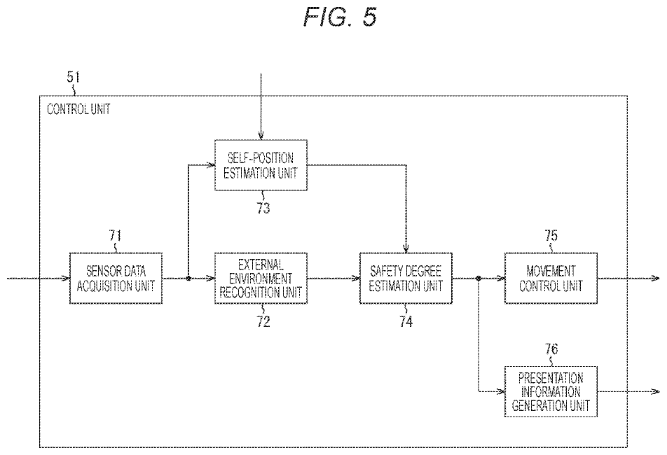

FIG. 5 is a block diagram showing a functional configuration example of the control unit 51.

Functional blocks of the control unit 51 illustrated in FIG. 5 are realized by execution of a predetermined program by a processor constituting the control unit 51.

The control unit 51 includes a sensor data acquisition unit 71, an external environment recognition unit 72, a self-position estimation unit 73, a safety degree estimation unit 74, a movement control unit 75, and a presentation information generation unit 76.

The sensor data acquisition unit 71 acquires sensor data from the sensor 21 and supplies the sensor data to the external environment recognition unit 72 and the self-position estimation unit 73.

The external environment recognition unit 72 acquires external environmental information by recognizing a state of an external environment (a moving space) on the basis of the sensor data from the sensor data acquisition unit 71. The external environmental information includes, for example, information indicating presence or absence of an obstacle (a dynamic object or a stationary object) in the external environment and an attribute (any one of a roadway, a sidewalk, a lawn in a park, and the like) of each region in the external environment. The acquired external environmental information is supplied to the safety degree estimation unit 74.

The self-position estimation unit 73 estimates a position of the self (moving body 20) on the basis of the GPS information received by the communication unit 52, and supplies position information indicating the position to the safety degree estimation unit 74. Furthermore, the self-position estimation unit 73 may estimate the self-position by simultaneous localization and mapping (SLAM) on the basis of the sensor data from the sensor data acquisition unit 71.

On the basis of the external environmental information from the external environment recognition unit 72, the safety degree estimation unit 74 estimates a safety degree according to a lapse of time of the moving body 20 in a moving state by using the self-position represented by the position information from the self-position estimation unit 73 as a reference. The estimated safety degree is supplied to the movement control unit 75 and the presentation information generation unit 76.

The movement control unit 75 controls movement of the moving body 20 on the basis of the safety degree from the safety degree estimation unit 74.

The presentation information generation unit 76 generates presentation information according to the estimated safety degree on the basis of the safety degree from the safety degree estimation unit 74. The generated presentation information is transmitted to a controller or the like, on which a captured image obtained by imaging the external environment is displayed, via the communication unit 52.

With such a configuration, the moving body 20 estimates the safety degree on the basis of the external environmental information, and moves and stops on the basis of the estimated safety degree.

Hereinafter, an example of estimating a safety degree for each divided space obtained by dividing the moving space in which the moving body 20 moves in the external environment will be described.

<3. Safety Degree Estimation for Each Divided Space Based on External Environmental Information>

A flow of movement control processing of the moving body 20 that autonomously moves will be described with reference to a flowchart of FIG. 5.

In step S11, the sensor data acquisition unit 71 acquires sensor data from the sensor 21.

In step S12, the external environment recognition unit 72 recognizes a state of an external environment on the basis of the sensor data from the sensor data acquisition unit 71. Specifically, the external environment recognition unit 72 detects a dynamic object or a stationary object as an obstacle in the external environment.

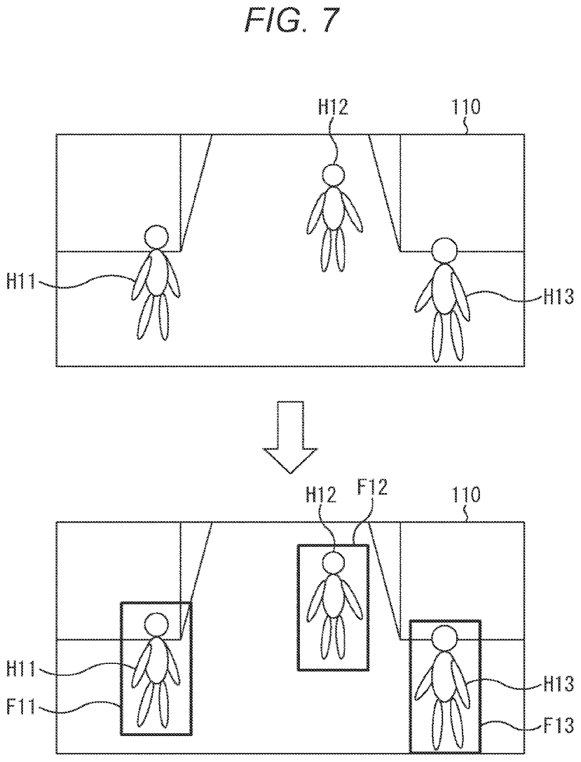

For example, it is assumed that a captured image 110 as illustrated in an upper part of FIG. 7 is captured by the sensor data acquisition unit 71 configured as a camera. The captured image 110 includes three persons H11, H12, and H13.

As illustrated in a lower part of FIG. 7, the external environment recognition unit 72 performs person detection on the captured image 110. In the captured image 110 in the lower part of FIG. 7, a frame F11 indicating that the person H11 has been detected, a frame F12 indicating that the person H12 has been detected, and a frame F13 indicating that the person H13 has been detected are displayed in a superimposed manner.

In an example of FIG. 7, a person is detected as a dynamic object in the external environment. However, in addition to the person, an animal such as a dog or a cat, or another moving body (for example, a drone) may be detected, or a stationary object such as a wall, a tree, a utility pole, or an electric wire may be detected.

Furthermore, the external environment recognition unit 72 may determine an attribute of each region in the external environment.

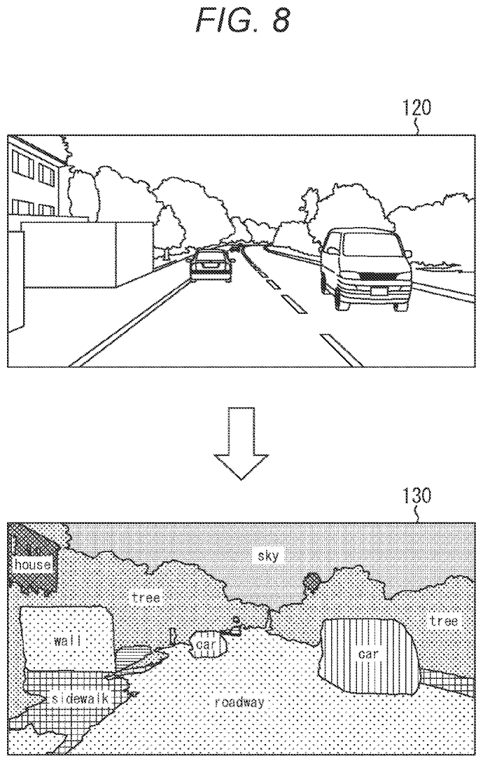

For example, it is assumed that a captured image 120 as illustrated in an upper part of FIG. 8 is captured by the sensor data acquisition unit 71 configured as the camera. The captured image 120 shows a state of a road on which cars travel.

The external environment recognition unit 72 determines an attribute of a subject on a pixel basis for the captured image 120 by semantic segmentation by machine learning such as deep learning, and labels the attribute for each pixel. Therefore, a processed image 130 as illustrated in a lower part of FIG. 8 is obtained. In the processed image 130, a car, a roadway, a sidewalk, a house, a wall, a tree, sky, and the like are determined as the attributes of the subject.

In this manner, the external environment recognition unit 72 acquires external environmental information by recognizing the state of the external environment.

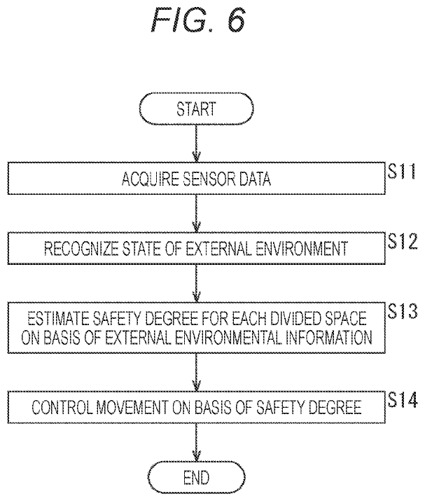

Returning to the flowchart of FIG. 6, in step S13, the safety degree estimation unit 74 estimates a safety degree for each divided space using a self-position as a reference on the basis of the external environmental information acquired by the external environment recognition unit 72.

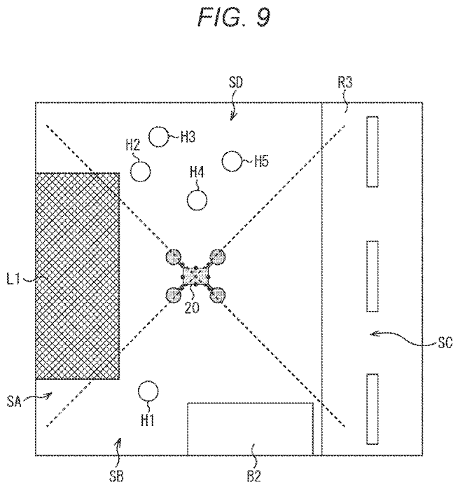

Here, estimation of the safety degree for each divided space during movement of the moving body 20 will be described with reference to FIG. 9.

FIG. 9 illustrates a state in which an external environment (a moving space) in which the moving body 20 configured as a drone moves (flies) is viewed from an upper surface of the moving body 20.

As illustrated in FIG. 9, the moving space in which the moving body 20 moves is divided into four divided spaces SA, SB, SC, and SD.

The divided space SA is a space opened to the left by 90° in the drawing with respect to the moving body 20, and the lawn L1 exists in the divided space SA.

The divided space SB is a space opened downward by 90° in the drawing with respect to the moving body 20, and the person H1 and the building B2 exist in the divided space SB.

The divided space SC is a space opened to the right by 90° in the drawing with respect to the moving body 20, and the roadway R3 exists in the divided space SC.

The divided space SD is a space opened upward by 90° in the drawing with respect to the moving body 20, and the four persons H2, H3, H4, and H5 exist in the divided space SD.

Here, the safety degree estimation unit 74 estimates a safety degree for each divided space by obtaining the number of dynamic objects existing in each of the divided spaces on the basis of the external environmental information indicating the presence or absence of the dynamic object in the external environment. For example, since there is no dynamic object in the divided space SA, it is estimated that a safety degree of the divided space SA is high. On the other hand, since the four persons H2, H3, H4, and H5 as dynamic objects exist in the divided space SD, it is estimated that a safety degree of the divided space SD is low.

Furthermore, the safety degree estimation unit 74 can also estimate the safety degree for each divided space by determining a possibility that a dynamic object enters each of the divided spaces on the basis of the external environmental information indicating the attribute of each region in the external environment. For example, since there is a low possibility that a person as a dynamic object enters the lawn L1 existing in the divided space SA, it is estimated that the safety degree of the divided space SA is high. On the other hand, since a car as a dynamic object travels back and forth in the roadway R3 existing in the divided space SC, it is estimated that a safety degree of the divided space SC is low.

Moreover, the safety degree estimation unit 74 may estimate the safety degree for each divided space by obtaining a proportion occupied by a stationary object in each of the divided spaces on the basis of the external environmental information indicating the presence or absence of the stationary object in the external environment. For example, since there is no stationary object in the divided space SA, it is estimated that the safety degree of the divided space SA is high. On the other hand, since a proportion occupied by the building B2 as a stationary object is relatively large in the divided space SB, it is estimated that a safety degree of the divided space SB is relatively low.

In the above, an example in which the safety degree during movement of the moving body 20 is estimated has been described, but it is also necessary to estimate a safety degree at the time of stop and after stop of the moving body 20.

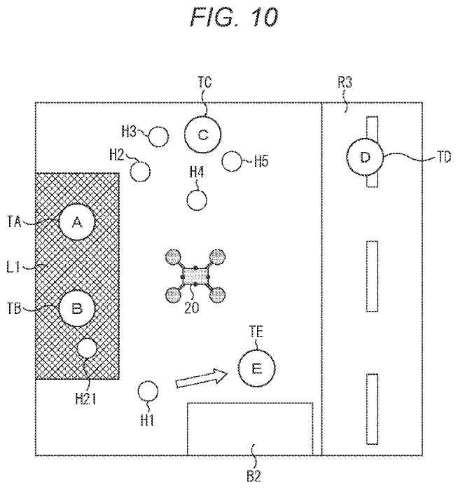

Therefore, with reference to FIG. 10, estimation of the safety degree at the time of stop and after stop of the moving body 20 will be described.

Similarly to FIG. 9, FIG. 10 illustrates a state in which the external environment (moving space) in which the moving body 20 configured as a drone moves (flies) is viewed from the upper surface of the moving body 20.

In an example of FIG. 10, five stop candidate positions TA, TB, TC, TD, and TE are set as candidates for a stop position (landing point) of the moving body 20.

The stop candidate positions TA and TB are set on the lawn L1, and a person H21 is present near the stop candidate position TB.

The stop candidate position TC is set on a walk near the four persons H2, H3, H4, and H5.

The stop candidate position TD is set on the roadway R3.

The stop candidate position TE is set on a walk near the building B2, and the person H1 moves toward the stop candidate position TE.

Here, the safety degree estimation unit 74 estimates a safety degree of the stop candidate position by obtaining current density of a dynamic object near the stop candidate position on the basis of the external environmental information indicating the presence or absence of the dynamic object in the external environment. For example, since there is no dynamic object near the stop candidate position TA, it is estimated that a safety degree of the stop candidate position TA is high. On the other hand, since the four persons H2, H3, H4, and H5 are densely present near the stop candidate position TC, it is estimated that a safety degree of the stop candidate position TC is low.

Furthermore, the safety degree estimation unit 74 can also estimate the safety degree of the stop candidate position according to an attribute of a region in which the stop candidate position is set on the basis of the external environmental information indicating the attribute of each region in the external environment. For example, since the stop candidate positions TA and TB are set on the lawn L1, it is estimated that safety degrees of the stop candidate positions TA and TB are high. On the other hand, since the stop candidate position TD is set on the roadway R3, it is estimated that a safety degree of the stop candidate position TD is low.

Moreover, the safety degree estimation unit 74 may estimate the safety degree of the stop candidate position by calculating a probability that the dynamic object passes through the stop candidate position in the future on the basis of the external environmental information indicating the presence or absence of the dynamic object and the external environmental information indicating the attribute of each region. For example, since the person H1 moves toward the stop candidate position TE, it is estimated that a safety degree of the stop candidate position TE is low.

Here, each item such as the presence or absence of the dynamic object and the attribute of each region in the external environment may be scored, and the safety degree of the stop candidate position may be estimated on the basis of the score.

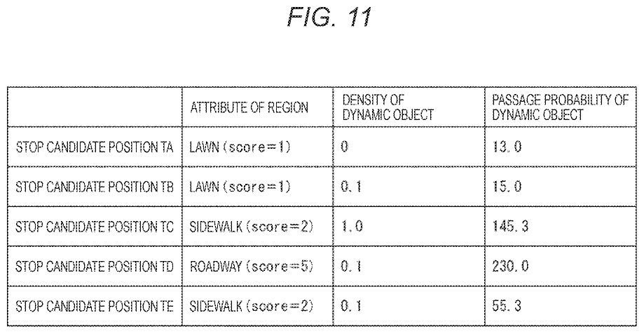

FIG. 11 is a table illustrating an example in which an attribute of a region, presence or absence (density) of a dynamic object, and a probability that the dynamic object passes are scored for each of the stop candidate positions TA, TB, TC, TD, and TE.

For the stop candidate position TA, the attribute of the region is the lawn and the score thereof is 1, the density of the dynamic object is 0, and the passage probability of the dynamic object is 13.0. For the stop candidate position TB, the attribute of the region is the lawn and the score thereof is 1, the density of the dynamic object is 0.1, and the passage probability of the dynamic object is 15.0. For the stop candidate position TC, the attribute of the region is the walk and the score thereof is 2, the density of the dynamic object is 1.0, and the passage probability of the dynamic object is 145.3. For the stop candidate position TD, the attribute of the region is the roadway and the score thereof is 5, the density of the dynamic object is 0.1, and the passage probability of the dynamic object is 230.0. For the stop candidate position TE, the attribute of the region is the walk and the score thereof is 2, the density of the dynamic object is 0.1, and the passage probability of the dynamic object is 55.3.

In this case, for example, the safety degree estimation unit 74 excludes the stop candidate position where the score of the attribute of the region exceeds 4 from a safety degree estimation target. In an example of FIG. 11, the stop candidate position TD set on the roadway R3 is excluded.

Then, the safety degree estimation unit 74 compares the scores of the respective stop candidate positions in descending order of priority, and estimates a stop candidate position having the smallest score as having the highest safety degree.

Furthermore, in a case where the moving body 20 configured as a drone flies in a living room, since no person steps on a top surface of a table, the top surface of the table is estimated to have a high safety degree as a stop candidate position. On the other hand, since there is a possibility that a person sits on a seat surface of a sofa, the seat surface of the sofa is estimated to have a low safety degree as a stop candidate position.

Note that the above-described estimation methods may be combined to estimate the safety degree at the time of stop and after stop of the moving body 20. In the example of FIG. 10, the stop candidate position TA has the low current density of the dynamic object in the vicinity thereof, is set on the safe lawn L1, and has the low probability that the dynamic object will pass in the future. Thus, it is estimated that the safety degree of the stop candidate position TA is the highest.

Returning to the flowchart of FIG. 6, in step S14, the movement control unit 75 controls movement of the moving body 20 on the basis of the safety degree estimated by the safety degree estimation unit 74.

Specifically, among the divided spaces where the safety degrees are estimated, the movement control unit 75 determines a movement route in the divided space estimated to have the highest safety degree, and controls the moving mechanism 54 to move along the movement route. Furthermore, the movement control unit 75 may control the moving mechanism 54 so as to move while reducing the maximum speed of the moving body 20, for example, in a place where there is a high possibility that a dynamic object such as a person passes, on the basis of the external environmental information used for estimating the safety degree.

Furthermore, among the stop candidate positions at which the safety degrees are estimated, the movement control unit 75 sets a stop candidate position estimated to have the highest safety degree as a stop position, and controls the moving mechanism 54 to stop at the stop position. Moreover, the movement control unit 75 may control the moving mechanism 54 not to stop at a place where there are many persons but to stop at a place where there is no person on the basis of the external environmental information used for estimating the safety degree.

According to the above processing, the safety degree according to the lapse of time of the moving body 20 in the moving state is estimated for each divided space, and the movement is controlled on the basis of the estimated safety degree. Therefore, it is possible to realize safer movement and stop without exposing the moving body 20 to danger due to presence of an obstacle or approach of a dynamic object.

In the above description, the example of estimating the safety degree for each divided space has been described. However, in a case where the moving body 20 moves according to a predetermined movement route, the safety degree may be estimated for each movement route.

Hereinafter, an example of estimating a safety degree for each movement route on which the moving body 20 moves in the external environment will be described.

<4. Safety Degree Estimation for Each Movement Route Based on External Environmental Information>

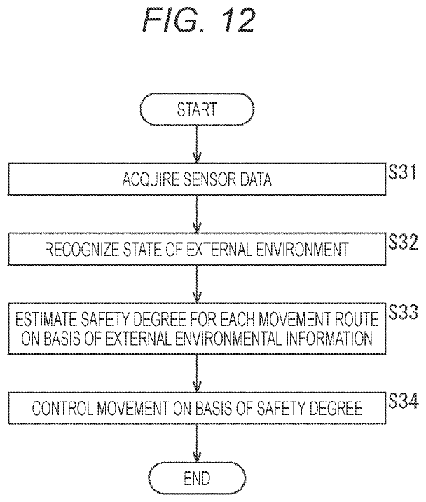

A flow of movement control processing of the moving body 20 that autonomously moves will be described with reference to a flowchart of FIG. 12.

Note that since processing of steps S31 and S32 in the flowchart of FIG. 12 is similar to the processing of steps S11 and S12 in the flowchart of FIG. 6, description thereof will be omitted.

That is, in step S33, the safety degree estimation unit 74 estimates a safety degree for each movement route using a self-position as a reference on the basis of the external environmental information acquired by the external environment recognition unit 72.

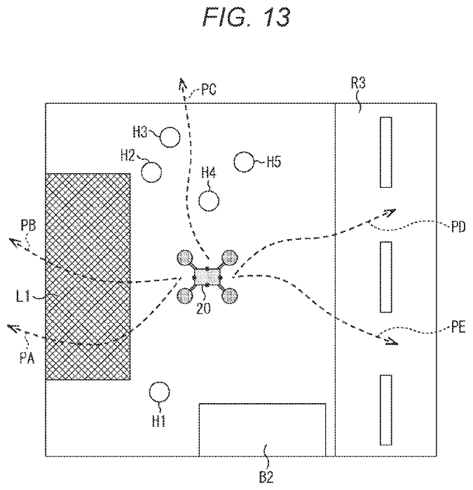

Here, estimation of the safety degree for each movement route during movement of the moving body 20 will be described with reference to FIG. 13.

Similarly to FIG. 9, FIG. 13 illustrates a state in which the external environment (moving space) in which the moving body 20 configured as a drone moves (flies) is viewed from the upper surface of the moving body 20.

In an example of FIG. 13, five movement candidate routes PA, PB, PC, PD, and PE are set as candidates for the movement route of the moving body 20.

The movement candidate routes PA and PB are set to advance leftward in the drawing and move on the lawn L1.

The movement candidate route PC is set to advance upward in the drawing and move among the four persons H2, H3, H4, and H5.

The movement candidate routes PD and PE are set to advance rightward in the drawing and move on the roadway R3.

Here, the safety degree estimation unit 74 estimates a safety degree for each movement route by obtaining a contact probability with a dynamic object on each movement candidate route on the basis of the external environmental information indicating the presence or absence of the dynamic object in the external environment.

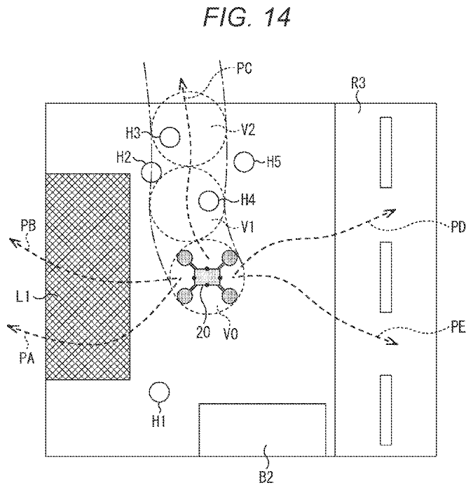

For example, as illustrated in FIG. 14, in a case where the moving body 20 moves on the movement candidate route PC, a contact probability on the movement candidate route PC is calculated by the number of persons included in a range from a passing region VO to a passing region V2 of the moving body 20. In an example of FIG. 14, the persons H2, H3, and H4 are included in the range from the passing region VO to the passing region V2 of the moving body 20.

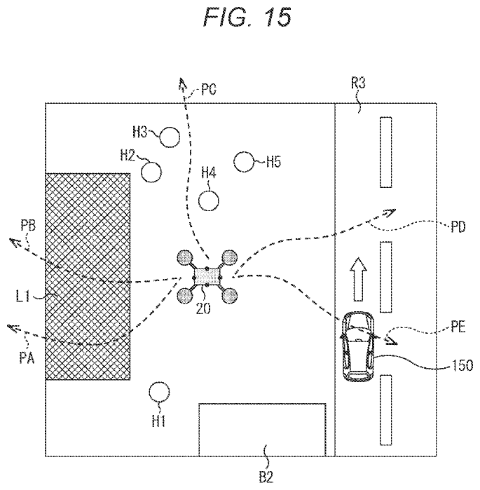

Moreover, the contact probability may be calculated on the basis of movement prediction data or planned movement data of a dynamic object. For example, as illustrated in FIG. 15, it is assumed that a car 150, which is a dynamic object, is predicted to move on the movement candidate route PD before the moving body 20 reaches the roadway R3. In this case, in the movement candidate route PD and the movement candidate route PE set to move on the roadway R3, a contact probability of the movement candidate route PE after the car 150 passes is calculated to be lower.

Furthermore, the safety degree estimation unit 74 can also estimate the safety degree for each movement route by giving a score regarding safety to each region existing on the movement candidate route on the basis of the external environmental information indicating the attribute of each region in the external environment. For example, a high score is given to the lawn L1, and a low score is given to the roadway R3.

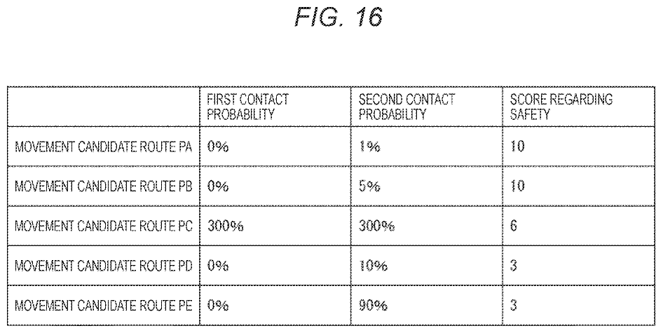

FIG. 16 is a table illustrating a first contact probability calculated in accordance with the number of dynamic objects, a second contact probability calculated in accordance with the movement prediction data and the planned movement data of the dynamic object, and a score regarding safety of a region existing on the movement candidate route for each movement candidate route.

For the movement candidate route PA, the first contact probability is 0%, the second contact probability is 1%, and the score regarding safety is 10. For the movement candidate route PB, the first contact probability is 0%, the second contact probability is 5%, and the score regarding safety is 10. For the movement candidate route PC, the first contact probability is 300%, the second contact probability is 300%, and the score regarding safety is 6. For the movement candidate route PD, the first contact probability is 0%, the second contact probability is 10%, and the score regarding safety is 3. For the movement candidate route PE, the first contact probability is 0%, the second contact probability is 90%, and the score regarding safety is 3.

In this case, the safety degree estimation unit 74 estimates that the movement candidate route satisfying a condition for each item has a high safety degree. For example, in a case where it is set that the first contact probability is 5% or less, the second contact probability is 70% or less, and the score regarding safety is 5 or more as the condition for each item, the movement candidate route PA and the movement candidate route PB are estimated to have high safety degrees.

Moreover, the safety degree estimation unit 74 estimates that a movement candidate route more reliably satisfying a high priority condition has the highest safety degree for each movement candidate route satisfying the above-described condition.

If the safety degree is estimated for each movement candidate route as described above, in step S34, the movement control unit 75 controls movement of the moving body 20 on the basis of the safety degree estimated by the safety degree estimation unit 74.

Specifically, the movement control unit 75 determines, as a movement route, a movement candidate route having the highest safety degree among the movement candidate routes for which the safety degrees are calculated, and controls the moving mechanism 54 to move along the movement route.

According to the above processing, the safety degree according to the lapse of time of the own machine in the moving state is estimated for each movement route, and the movement is controlled on the basis of the estimated safety degree.

Therefore, it is possible to realize safer movement and stop without exposing the moving body 20 to danger due to presence of an obstacle or approach of a dynamic object.

In the above description, the safety degree is estimated on the basis of the external environmental information acquired in real time by the external environment recognition unit 72. The present invention is not limited thereto, and the safety degree can be estimated more accurately by using a past movement result (history of movement control) of the moving body 20 in addition to the external environmental information.

Therefore, hereinafter, a configuration in which the past movement result of the moving body 20 is held as history information, and the safety degree is estimated on the basis of the external environmental information and the history information will be described.

<5. Safety Degree Estimation Based on External Environmental Information and History Information>

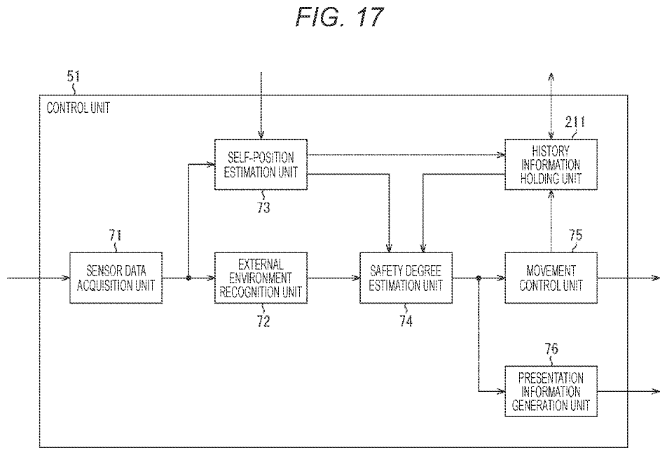

(Functional Configuration Blocks of Control Unit) FIG. 17 is a block diagram showing another functional configuration example of the control unit 51.

The control unit 51 in FIG. 17 includes a history information holding unit 211, in addition to the configuration similar to the control unit 51 in FIG. 5.

The history information holding unit 211 holds a movement result (history of movement control) of the moving body 20 from the movement control unit 75 as history information. At this time, the history information is held in association with the position information indicating the position of the moving body 20 from the self-position estimation unit 73. In addition to route information indicating a movement route on which the moving body 20 has actually moved, the history information includes external environmental information acquired in the movement route. That is, the history information can be said to be external environmental information indicating presence or absence of an obstacle in a movement route on which the moving body 20 has moved in the past and an attribute of each region.

Note that the history information may be supplied to the history information holding unit 211 from another moving body, an external device, a server on a network, or the like via the communication unit 52.

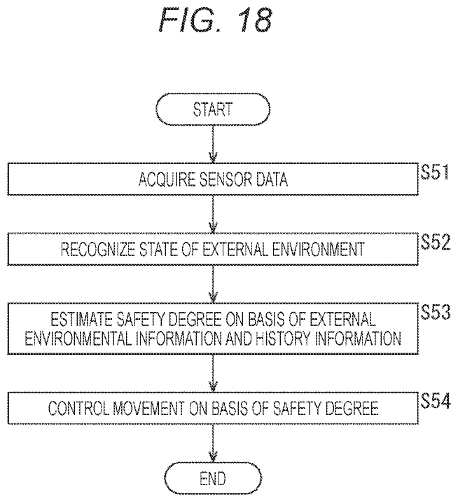

(Flow of Movement Control Processing) Next, a flow of movement control processing of the moving body 20 by the control unit 51 of FIG. 17 will be described with reference to a flowchart of FIG. 18.

Note that processing of steps S51, S52, and S54 in the flowchart of FIG. 18 is similar to the processing of steps S11, S12, and S14 in the flowchart of FIG. 6 and the processing of steps S31, S32, and S34 in the flowchart of FIG. 12, respectively, and thus description thereof will be omitted.

That is, in step S53, the safety degree estimation unit 74 estimates a safety degree on the basis of the external environmental information acquired by the external environment recognition unit 72 and the history information held in the history information holding unit 211. The safety degree may be estimated for each divided space described above, or may be estimated for each movement route.

According to the above processing, since the safety degree is estimated more accurately on the basis of the history information indicating the past movement result in addition to the external environmental information acquired in real time, it is possible to realize much safer movement and stop.

### 6. Examples of Presentation Information

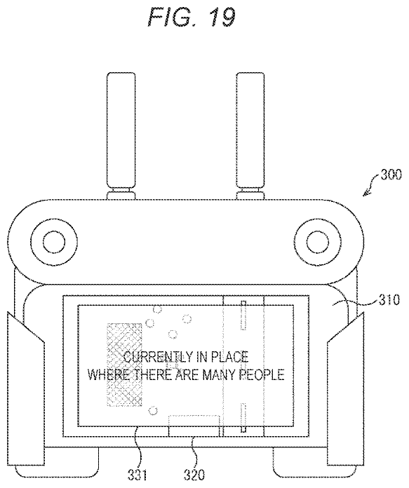

FIG. 19 is a diagram illustrating a configuration example of a controller for operating the moving body 20.

A controller 300 in FIG. 19 is configured such that a smartphone 310 is attached to a dedicated transmitter. As described above, the moving body 20 may be configured to move according to a signal from the controller 300, or may be configured to autonomously move.

A captured image obtained by imaging an external environment with the sensor 21 configured as a camera during movement of the moving body 20 is displayed on a screen 320 of the smartphone 310. The captured image may be a moving image or a still image.

Furthermore, presentation information generated by the presentation information generation unit 76 on the basis of an estimated safety degree is displayed on the screen 320 of the smartphone 310.

Specifically, presentation information indicating a possibility of appearance of a dynamic object is generated by the presentation information generation unit 76 on the basis of presence or absence of the dynamic object in the external environment and an attribute of each region in the external environment.

In an example of FIG. 19, a warning 331 indicating that the moving body 20 is currently moving in a place where there are many people is displayed on the screen 320 as the presentation information.

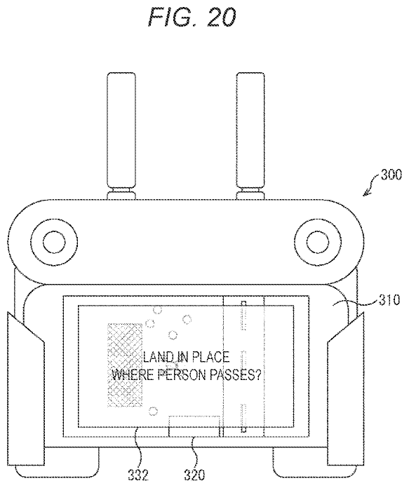

Furthermore, in a case where a pilot manually moves the moving body 20 by operating the controller 300, as illustrated in FIG. 20, a warning 332 for confirming to the pilot whether or not to stop (land) the moving body 20 in a place where a person passes may be displayed on the screen 320 as the presentation information.

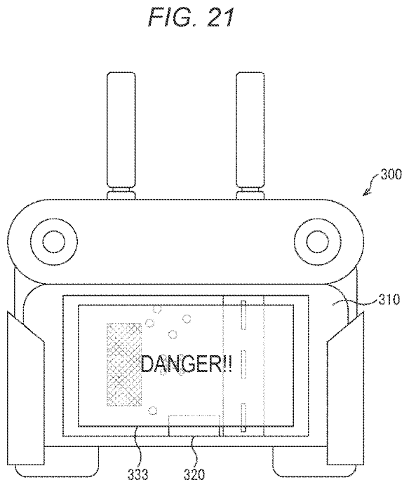

As illustrated in FIG. 21, a warning 333 indicating that a possibility of appearance of a dynamic object is high and there is a great danger that the moving body 20 comes into contact with the dynamic object is displayed on the screen 320 as the presentation information.

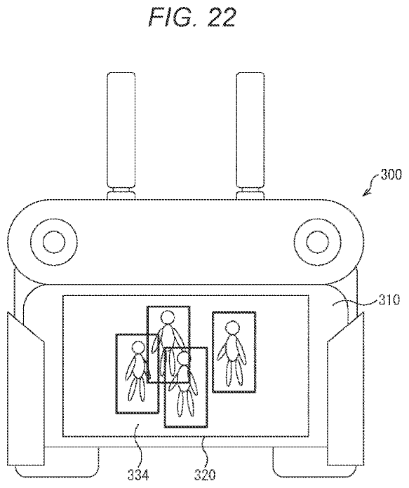

As illustrated in FIG. 22, a captured image 334 in which four persons and frames indicating that the respective persons have been detected are displayed in a superimposed manner may be displayed on the screen 320 as the presentation information.

Furthermore, the presentation information generation unit 76 can also generate presentation information for recommending, for example, a place through which a dynamic object such as a person does not pass as a passing point or a stop point of the moving body 20 on the basis of the attribute of each region in the external environment.

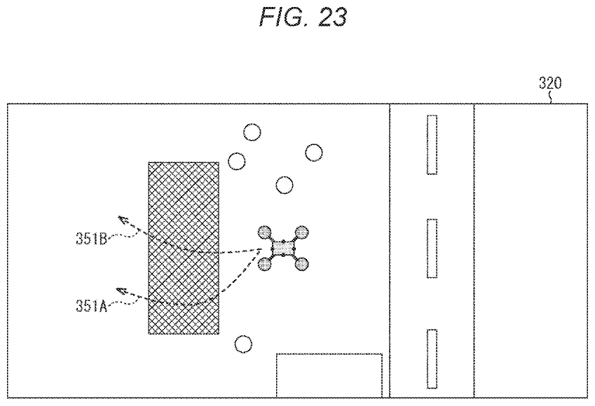

For example, as illustrated in FIG. 23, on the screen 320, pieces of recommended route information 351A and 351B for recommending a movement route of the moving body 20 are displayed as the presentation information on a captured image obtained by imaging an external environment of the moving body 20.

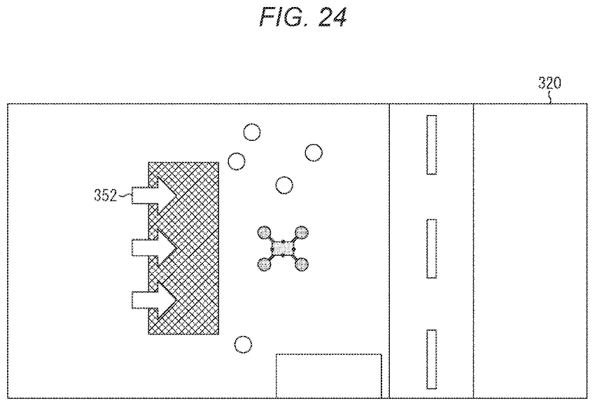

Furthermore, as illustrated in FIG. 24, on the screen 320, recommended stop position information 352 for recommending a stop point of the moving body 20 may be displayed as the presentation information on a captured image obtained by imaging an external environment of the moving body 20.

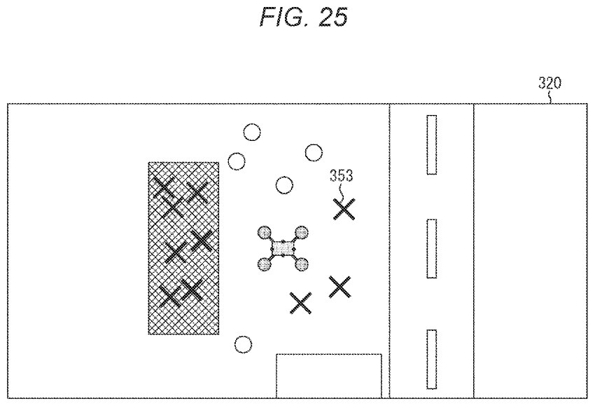

Moreover, as illustrated in FIG. 25, track record information 353 indicating a position where the moving body 20 has stopped in the past may be displayed as presentation information for recommending a stop point on a captured image obtained by imaging an external environment of the moving body 20.

As described above, the presentation information indicating the appearance possibility of the dynamic object and the presentation information for recommending the passing point or the stop point of the moving body 20 are presented to a user. Therefore, the moving body 20 can move while avoiding a dangerous place or move along a movement route desired by the user, and can stop at a safer place.

The series of processing described above can be executed by hardware or software. In a case where the series of processing is executed by the software, a program constituting the software is installed from a network or a program recording medium.

Note that an embodiment of the technology according to the present disclosure is not limited to the above-described embodiment, and various modifications can be made without departing from the scope of the technology according to the present disclosure.

Furthermore, the effects described in the present specification are merely examples and are not limited, and there may be other effects.

Moreover, the technology according to the present disclosure can have the following configurations.

(1)

A moving body including:

a safety degree estimation unit that estimates a safety degree according to a lapse of time of its own machine in a moving state on the basis of external environmental information regarding an external environment; and

a movement control unit that controls movement of the own machine on the basis of the estimated safety degree.

(2)

The moving body according to (1),

in which the safety degree estimation unit estimates the safety degree during movement, at a time of stop, and after stop of the own machine.

(3)

The moving body according to (2),

in which the external environmental information includes information indicating presence or absence of a dynamic object in the external environment.

(4)

The moving body according to (3),

in which the safety degree estimation unit estimates the safety degree on the basis of a contact probability with the dynamic object.

(5)

The moving body according to (4),

in which the safety degree estimation unit calculates the contact probability on the basis of movement prediction data or planned movement data of the dynamic object.

(6)

The moving body according to any one of (2) to (5),

in which the external environmental information further includes an attribute of each region in the external environment.

(7)

The moving body according to (6),

in which the safety degree estimation unit estimates the safety degree on the basis of the attribute of each of the regions.

(8)

The moving body according to (6),

in which the attribute is determined by semantic segmentation.

(9)

The moving body according to any one of (2) to (8),

in which the external environmental information further includes information indicating presence or absence of a stationary object in the external environment.

(10)

The moving body according to any one of (2) to (9), further including:

an external environment recognition unit that acquires the external environmental information by recognizing a state of the external environment using sensor data.

(11)

The moving body according to (10), further including:

a history information holding unit that holds a movement result of the own machine based on the safety degree as history information,

in which the safety degree estimation unit estimates the safety degree on the basis of the external environmental information acquired by the external environment recognition unit and the history information held by the history information holding unit.

(12)

The moving body according to any one of (2) to (11),

in which the safety degree estimation unit estimates the safety degree for each divided space obtained by dividing the external environment into a plurality of spaces.

(13)

The moving body according to (12),

in which the movement control unit controls movement in the divided space estimated to have the highest safety degree.

(14)

The moving body according to any one of (2) to (11),

in which the safety degree estimation unit estimates the safety degree for each movement route in the external environment.

(15)

The moving body according to (14),

in which the movement control unit controls movement on the movement route estimated to have the highest safety degree.

(16)

The moving body according to any one of (2) to (15), further including:

a presentation information generation unit that generates presentation information according to the estimated safety degree.

(17)

The moving body according to (16),

in which the presentation information generation unit generates the presentation information indicating a possibility of appearance of a dynamic object on the basis of presence or absence of the dynamic object in the external environment.

(18)

The moving body according to (16),

in which the presentation information generation unit generates the presentation information for recommending a passing point or a stop point of the own machine on the basis of an attribute of each region in the external environment.

(19)

A control method,

in which a moving body

estimates a safety degree according to a lapse of time of its own machine in a moving state by using external environmental information regarding an external environment, and

controls movement of the own machine on the basis of the estimated safety degree.

(20)

A program for causing a processor to execute processing of:

estimating a safety degree according to a lapse of time of a moving body in a moving state by using external environmental information regarding an external environment; and

controlling movement of the moving body on the basis of the estimated safety degree.

### REFERENCE SIGNS LIST

10 Moving body
20 Moving body
21 Sensor
51 Control unit
52 Communication unit
53 Storage unit
54 Moving mechanism
71 Sensor data acquisition unit
72 External environment recognition unit
73 Self-position estimation unit
74 Safety degree estimation unit
75 Movement control unit
76 Presentation information generation unit
211 History information holding unit

1. A moving body comprising:
a safety degree estimation unit that estimates a safety degree according to a lapse of time of its own machine in a moving state on a basis of external environmental information regarding an external environment; and
a movement control unit that controls movement of the own machine on a basis of the estimated safety degree.

2. The moving body according to claim 1,
wherein the safety degree estimation unit estimates the safety degree during movement, at a time of stop, and after stop of the own machine.

3. The moving body according to claim 2,
wherein the external environmental information includes information indicating presence or absence of a dynamic object in the external environment.

4. The moving body according to claim 3,
wherein the safety degree estimation unit estimates the safety degree on a basis of a contact probability with the dynamic object.

5. The moving body according to claim 4,
wherein the safety degree estimation unit calculates the contact probability on a basis of movement prediction data or planned movement data of the dynamic object.

6. The moving body according to claim 2,
wherein the external environmental information further includes an attribute of each region in the external environment.

7. The moving body according to claim 6,
wherein the safety degree estimation unit estimates the safety degree on a basis of the attribute of each of the regions.

8. The moving body according to claim 6,
wherein the attribute is determined by semantic segmentation.

9. The moving body according to claim 2,
wherein the external environmental information further includes information indicating presence or absence of a stationary object in the external environment.

10. The moving body according to claim 2, further comprising:
an external environment recognition unit that acquires the external environmental information by recognizing a state of the external environment using sensor data.

11. The moving body according to claim 10, further comprising:
a history information holding unit that holds a movement result of the own machine based on the safety degree as history information,
wherein the safety degree estimation unit estimates the safety degree on a basis of the external environmental information acquired by the external environment recognition unit and the history information held by the history information holding unit.

12. The moving body according to claim 2,
wherein the safety degree estimation unit estimates the safety degree for each divided space obtained by dividing the external environment into a plurality of spaces.

13. The moving body according to claim 12,
wherein the movement control unit controls movement in the divided space estimated to have the highest safety degree.

14. The moving body according to claim 2,
wherein the safety degree estimation unit estimates the safety degree for each movement route in the external environment.

15. The moving body according to claim 14,
wherein the movement control unit controls movement on the movement route estimated to have the highest safety degree.

16. The moving body according to claim 2, further comprising:
a presentation information generation unit that generates presentation information according to the estimated safety degree.

17. The moving body according to claim 16,
wherein the presentation information generation unit generates the presentation information indicating a possibility of appearance of a dynamic object on a basis of presence or absence of the dynamic object in the external environment.

18. The moving body according to claim 16,
wherein the presentation information generation unit generates the presentation information for recommending a passing point or a stop point of the own machine on a basis of an attribute of each region in the external environment.

19. A control method,
wherein a moving body
estimates a safety degree according to a lapse of time of its own machine in a moving state by using external environmental information regarding an external environment, and
controls movement of the own machine on a basis of the estimated safety degree.

20. A program for causing a processor to execute processing of:
estimating a safety degree according to a lapse of time of a moving body in a moving state by using external environmental information regarding an external environment; and
controlling movement of the moving body on a basis of the estimated safety degree.
